(19) United States
(12) Patent Application Publication
(10) Pub. No.: US 2017/0167740 A1
(43) Pub. Date: Jun. 15, 2017

(54) APPARATUS AND METHOD FOR CONTROLLING TEMPERATURE IN AIR CONDITIONING SYSTEM

(71) Applicant: SAMSUNG ELECTRONICS CO., LTD., Suwon-si (KR)

(72) Inventors: Daeeun YI, Seoul (KR); Seong Hwan OH, Yongin-si (KR); Kyungjae KIM, Suwon-si (KR); Jeongil SEO, Seoul (KR); Kwanwoo SONG, Yongin-si (KR); Hyejung CHO, Anyang-si (KR); Jae Eun KANG, Suwon-si (KR); Chang-Han KIM, Goyang-si (KR); Jongyoub RYU, Suwon-si (KR); Changhyun LEE, Suwon-si (KR)

(21) Appl. No.: 15/374,142

(22) Filed: Dec. 9, 2016

(30) Foreign Application Priority Data
Dec. 10, 2015 (KR) 10-2015-0176062

(51) Int. Cl. F24F 11/00; G05B 15/02

(52) U.S. Cl. CPC F24F 11/006; F24F 11/0034; F24F 11/0079; F24F 11/008; F24F 11/0012; G05B 15/02; F24F 2011/0061; F24F 2011/0013; F24F 2011/0049; F24F 2011/0075

(57) ABSTRACT

An air conditioning system of a building is provided. A method for controlling air conditioning of a building includes controlling a temperature of a heat medium based on a reservation rate for using spaces in the building and outside weather, and controlling a flow of the heat medium based on at least one sensing information measured in the spaces.

### CROSS-REFERENCE TO RELATED APPLICATION

The present application is based on and claims priority under 35 U.S.C. §119 to a Korean patent application filed in the Korean Intellectual Property Office on Dec. 10, 2015, and assigned Serial No. 10-2015-0176062, the disclosure of which is incorporated by reference herein in its entirety.

### TECHNICAL FIELD

The present disclosure relates generally to an air conditioning system of a building.

### BACKGROUND

An air conditioning system may be used in a building in order to control an indoor temperature. The air conditioning system regulates the temperature by distributing hot or cool air or water into the inside through pipes. Hence, the temperature control of the air conditioning system relies on a characteristic or status of the distributed material, and a status of a fan for transporting the heated or refrigerated air of the distributed material into the inside.

A typical air conditioning system is controlled by a building manager. Accordingly, the cold/hot water is mostly managed at fixed temperatures and arbitrarily controlled by the building manager. As a result, it is not easy to fulfill adaptive temperature control by immediately responding to an environmental change.

The above information is presented as background information only to assist with an understanding of the present disclosure. No determination has been made, and no assertion is made, as to whether any of the above might be applicable as prior art with regard to the present disclosure.

### SUMMARY

To address the above-discussed deficiencies, it is an example aspect of the present disclosure to provide an apparatus and a method for controlling a temperature of spaces in an air conditioning system.

Another example aspect of the present disclosure is to provide an apparatus and a method for regulating a temperature of a medium flowing into spaces in an air conditioning system.

Yet another example aspect of the present disclosure is to provide an apparatus and a method for controlling a flow of a medium flowing into spaces in an air conditioning system.

Still another example aspect of the present disclosure is to provide an apparatus and a method for controlling a rotational speed of a fan installed in spaces in an air condition system.

A further example aspect of the present disclosure is to provide an apparatus and a method for controlling a temperature and a flow of a medium, and a rotational speed of a fan based on indoor and ambient environment information of a building in an air conditioning system.

According to one example aspect of the present disclosure, a method for controlling air conditioning of a building includes controlling a temperature of a heat medium based on a reservation rate for using spaces in the building and weather outside, and controlling a flow of the heat medium based on at least one sensing information measured in the spaces.

According to another example aspect of the present disclosure, an apparatus for controlling air conditioning of a building includes a communication unit comprising communication circuitry configured to receive information and a control unit comprising processing circuitry configured to execute an operation to control the air conditioning of the building based on the information, wherein the operation controls a temperature of a heat medium based on a reservation rate for using spaces in the building and weather outside, and controls a flow of the heat medium based on at least one sensing information measured in the spaces.

Other aspects, advantages, and salient features of the disclosure will become apparent to those skilled in the art from the following detailed description, which, taken in conjunction with the annexed drawings, discloses example embodiments of the disclosure.

### BRIEF DESCRIPTION OF THE DRAWINGS

The above and other aspects, features, and advantages of certain example embodiments of the present disclosure will be more apparent from the following detailed description, taken in conjunction with the accompanying drawings, in which like reference numerals refer to like elements, and wherein:

FIG. 1 is a block diagram illustrating an example air conditioning system according to an example embodiment of the present disclosure;

FIG. 2 is a diagram illustrating example operations of an air conditioning system according to an example embodiment of the present disclosure;

FIG. 3 is a block diagram illustrating an example control device in an air conditioning system according to an example embodiment of the present disclosure;

FIG. 4 is a block diagram illustrating an example control device in an air conditioning system according to another example embodiment of the present disclosure;

FIG. 5 is a flowchart illustrating example operations of a control device in an air conditioning system according to an example embodiment of the present disclosure;

FIG. 6 is a flowchart illustrating example operations of a control device in an air conditioning system according to another example embodiment of the present disclosure;

FIG. 7 is a flowchart illustrating example operations of a control device in an air conditioning system according to an example embodiment of the present disclosure;

FIGS. 8A, 8B and 8C are diagrams illustrating an example space reservation pattern determined in an air conditioning system according to an example embodiment of the present disclosure;

FIG. 9 is a diagram illustrating an example target temperate change rate in an air conditioning system according to an example embodiment of the present disclosure;

FIG. 10 is a flowchart illustrating an example method for controlling a temperature in an air conditioning system according to an example embodiment of the present disclosure;

FIG. 11 is a flowchart illustrating an example method for determining a space use pattern in an air conditioning system according to an example embodiment of the present disclosure;

FIG. 12 is a flowchart illustrating an example method for determining a space use pattern in an air conditioning system according to an example embodiment of the present disclosure;

FIG. 13 is a diagram illustrating an example of machine learning in an air conditioning system according to an example embodiment of the present disclosure; and

FIG. 14 is a flowchart illustrating an example machine learning method in an air conditioning system according to an example embodiment of the present disclosure.

Throughout the drawings, like reference numerals will be understood to refer to like parts, components and structures.

### DETAILED DESCRIPTION

Hereinafter, an operational principle of various example embodiments is described in greater detail with reference to the accompanying drawings. In the following description, well-known functions or constitutions may not be described in detail if they would unnecessarily obscure the disclosure. Also, terminologies to be described below are defined in consideration of functions in the various example embodiments and may vary depending on a user's or an operator's intention or practice. Thus, their definitions should be defined based on all the contents of the specification.

Example embodiments of the present disclosure provide a technique for controlling a temperature of spaces in an air conditioning system.

Hereafter, terms indicating spaces in a building, terms indicating means used for air conditioning, terms indicating environmental factors near the building, terms indicating components of the air conditioning system, terms indicating information used for the air conditioning, and terms indicating components of a device are described to aid in understanding. Accordingly, the present disclosure is not limited to those terms and may adopt other terms having technically equivalent meanings.

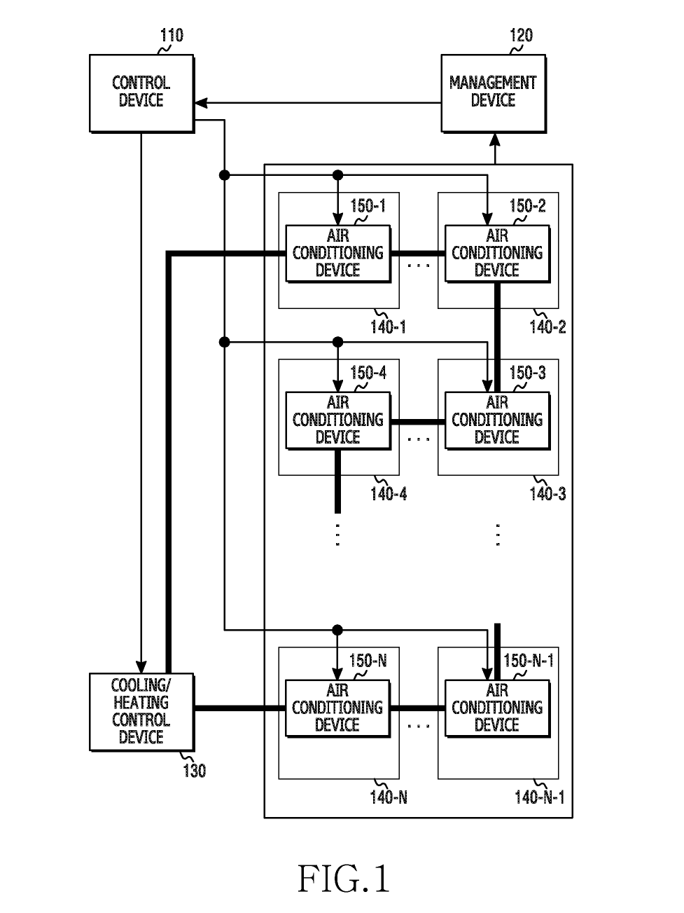

FIG. 1 is a block diagram illustrating an example air conditioning system according to an example embodiment of the present disclosure. Referring to FIG. 1, the air conditioning system includes a control device 110, a management device 120, a cooling/heating control device 130, a plurality of spaces 140-1 through 140-N, and a plurality of air conditioning devices 150-1 through 150-N.

The control device 110 controls operations of the cooling/heating control device 130 and the air conditioning devices 150-1 through 150-N. For example, the control device 110 may control a temperature of material (e.g., water) flowing from the cooling/heating control device 130 into the spaces 140-1 through 140-N to provide temperature control. The control device 110 may control a flow of material (e.g., water) flowing from the cooling/heating control device 130 into the spaces 140-1 through 140-N for the sake of temperature control. The control device 110 may control an air speed generated by fans of the air conditioning devices 150-1 through 150-N. The air speed may be controlled by a rotational speed of the fans, for example, a Revolutions Per Minute (RPM). To control the cooling/heating control device 130 and the air conditioning devices 150-1 through 150-N, the control device 110 may receive necessary information from the management device 120.

The control device 110, which may, for example, be an electronic device, may be implemented in various ways. The control device 110 may, for example, be stationary equipment or portable equipment. For example, the control device 110 may be a device, as a computable (e.g., including processing circuitry) device, designed to control the air conditioning system. For example, the control device 110 may be a general computing device, such as a Personal Computer (PC), a work station, a smart phone, a Personal Data Assistant (PDA), and a tablet PC, with air conditioning control functionality, but is not limited thereto. For example, the air conditioning control functionality according to various example embodiments may be attained by installing an application or a hardware component for a corresponding function.

The management device 120 stores information of a building including the spaces 140-1 through 140-N for the air conditioning. The building information may be input by a building manager. The building information may be generated by a sensor or a remote user and provided to the management device 120 over a wired or wireless network. Further, the management device 120 provides the control device 110 with necessary information for the controlling of the control device 110. For example, the necessary information may include, for example, and without limitation, at least one of a reservation rate for using the spaces 140-1 through 140-N, a vacancy rate of the spaces 140-1 through 140-N, locations and structures of the spaces 140-1 through 140-N, an air temperature outside the building, weather, insolation, a room setting temperature of the spaces 140-1 through 140-N, and fan conditions of the air conditioning devices 150-1 through 150-N.

The cooling/heating control device 130 circulates the temperature control material throughout the spaces 140-1 through 140-N, for example, along pipes. For example, the temperature control material, may be water, and may be cool water or hot water. The cooling/heating control device 130 chills or heats the temperature control material. For the circulation of the material, the cooling/heating control device 130 may include a device for applying pressure to the material such as, for example, and without limitation, a pump. To cool or heat the material, the cooling/heating control device 130 may include a device for lowering the temperature such as, for example, and without limitation a freezer, or a device for supplying the heat such as, for example, and without limitation, a boiler.

The temperature of the spaces 140-1 through 140-N is controlled. According to various example embodiments, a purpose of the spaces 140-1 through 140-N may be defined variously. For example, the spaces 140-1 through 140-N may be used for various purposes such as, for example, and without limitation, residence, office, laboratory, sports facility, and commercial facility, alone or in combination. The spaces 140-1 through 140-N may be constructed independently, or some of the spaces 140-1 through 140-N may be connected. The spaces 140-1 through 140-N may occupy different locations in the building, and some of the spaces 140-1 through 140-N may have different structures and sizes.

The air conditioning devices 150-1 through 150-N control the temperature of the spaces 140-1 through 140-N. At least one of the air conditioning devices 150-1 through 150-N is installed in each of the spaces 140-1 through 140-N. The air conditioning devices 150-1 through 150-N provide the spaces 140-1 through 140-N with the hot air or cool air of the material supplied from the cooling/heating control device 130 through the pipes. For doing so, the air conditioning devices 150-1 through 150-N may include a device which generates an air flow, for example, wind, such as a fan. Further, the air conditioning devices 150-1 through 150-N may include at least one sensor for collecting information about their corresponding space.

In FIG. 1, the temperature control material flowing though the pipes transports the heat or the cool air into the air conditioning devices 150-1 through 150-N. For example, the material is a medium or a delivery means which transports the heat or the cool air. The material, which is fluid, may, for example, be gas or liquid. For example, the material may be water. Hereafter, to aid in understanding, the temperature control material may be referred to as a heat medium. In this disclosure, the heat medium recovers the heat in the spaces 140-1 through 140-N by transporting the heat generated by the cooling/heating control device 130 into the spaces 140-1 through 140-N, or by transporting the cool air generated by the cooling/heating control device 130 into the spaces 140-1 through 140-N. For example, the heat medium may be used as the material for transporting the heat throughout the spaces 140-1 through 140-N.

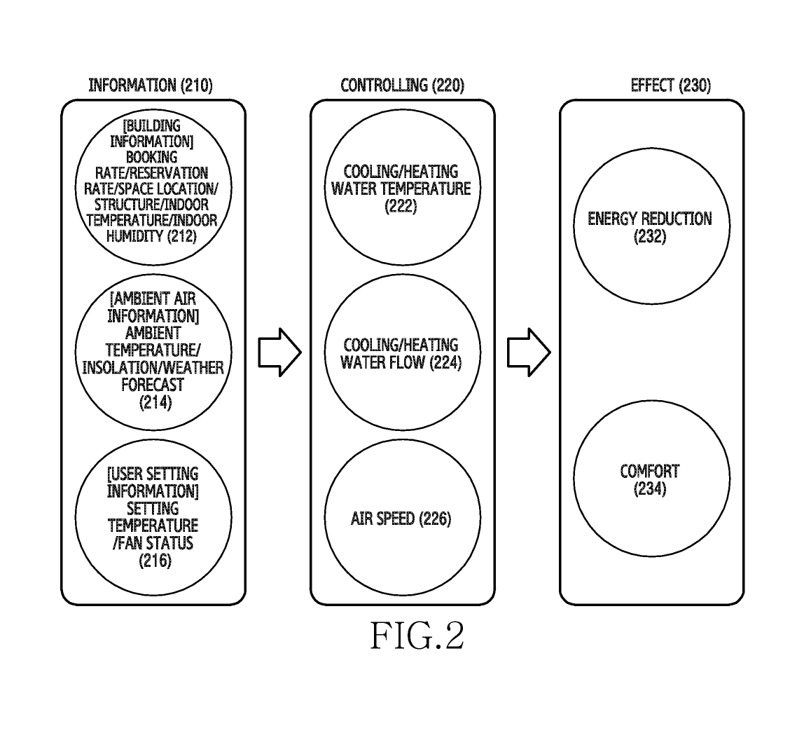

FIG. 2 is a diagram illustrating example operations of an air conditioning system according to an example embodiment of the present disclosure. Referring to FIG. 2, controlling 220 may be performed based on information 210.

The information 210 may include building information 212, ambient air information 214, and user setting information 216. For example, the building information 212 may include a reservation rate, an occupancy rate, a space location, a space structure, an indoor temperature, an indoor humidity, and so on, but is not limited thereto. The occupancy rate, the indoor temperature, and the indoor humidity may be obtained, for example, through sensing. The ambient air information 214 may include an ambient temperature, an insolation, and a weather report. The ambient temperature and the insolation may be obtained, for example, through sensing or from an external server (e.g., a weather center server). The weather report may be obtained from an external server (e.g., a weather center server). The user setting information 216 may include a setting temperature, a fan status, and so on, but is not limited thereto.

The controlling 220 controls a cool/hot water temperature 222, a cool/hot water flow 224, and an air speed 226. The controlling 220 is performed based on the information 210, and its detailed process may be performed in various manners. For example, the controlling 220 may be executed according to predefined setting values corresponding to the values of the information 210, adaptively executed according to a status specified by the information 210, or the like, but is not limited thereto. Further, the process or the setting values of the controlling 220 may be updated by learning based on cumulative statistics. Hence, an effect 230 such as energy reduction 232 and comfort 234 may be attained.

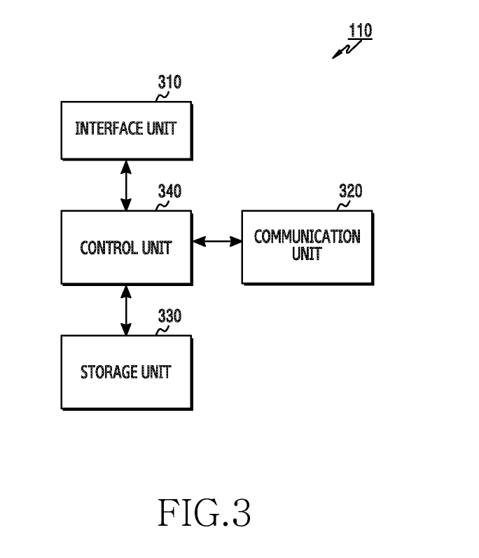

FIG. 3 is a block diagram illustrating an example control device in an air conditioning system according to an example embodiment of the present disclosure. Hereafter, terms such as parts and units indicate a unit for processing at least one function or operation, and may be implemented using hardware (e.g., circuitry), software, or a combination of hardware and software. Referring to FIG. 3, the control device 110 includes an interface unit (e.g., including interface circuitry) 310, a communication unit (e.g., including communication circuitry) 320, a storage unit 330, and a control unit (e.g., including control or processing circuitry) 340.

The interface unit 310 may, for example, include various interface circuitry that outputs information and detects a user input. The interface unit 310 may forward a command or data input from a user to the control unit 340. For doing so, the interface unit 310 may include at least one hardware module including various circuitry for the outputting and the inputting. For example, the hardware module may include various interface circuitry, such as, for example, and without limitation, at least one of a sensor, a keyboard, a keypad, a speaker, a microphone, a touch screen, a Liquid Crystal Display (LCD), a Light Emitting Diode (LED), a Light emitting Polymer Display (LPD), an Organic Light Emitting Diode (OLED), an Active Matrix OLED (AMOLED), and a Flexible LED (FLED). For example, the interface unit 310 may provide data of a user input from the keyboard or the keypad, to the control unit 340. The interface unit 310 may provide the control unit 340 with data of a user touch input (e.g., tap, press, pinch, stretch, slide, swipe, rotate) through the touch screen. The interface unit 310 may output a command or data received from the control unit 340 through an input/output device (e.g., a speaker or a display). The interface unit 310 displays information and thus may be referred to as a display unit. The interface unit 310 detects the user input and thus may be referred to as an input unit.

The communication unit 320 may include various communication circuitry that transmits and receives data to and from another device. For example, the communication circuitry of the communication unit 320 may convert a signal to a bit string and vice versa according to a physical layer standard of a network. Herein, the data may be transmitted over a wired channel or a radio (e.g., wireless) channel. For example, in the wireless communication, the communication unit 320 may generate complex symbols by encoding and modulating a transmit bit stream. In the wireless communication, the communication device 320 may restore a received bit stream by demodulating and decoding a baseband signal. In the wireless communication, the communication unit 320 may up-convert a baseband signal to a Radio Frequency (RF) signal, transmit it over an antenna, and down-convert an RF signal received over the antenna to a baseband signal. The communication unit 320 may include various circuitry that transmits and receives signals as mentioned above. Hence, the communication unit 320 may be referred to as a transmitter, a receiver, or a transceiver. Hereafter, the transmission and the reception over the radio channel include the above-described processing of the communication unit 320.

The storage unit 330 may store a basic program for the operations of the device, an application program, and data such as setting information. For example, the storage unit 330 may store setting information, environment information, and measurement information for the air conditioning system control. The storage unit 330 provides the stored data based on a request of the control unit 340.

The control unit 340 may include various processing circuitry that controls operations of the control device 110. For example, the control unit 340 transmits and receives signals through the communication unit 320. The control unit 340 records and reads data in and from the storage unit 330. For doing so, the control unit 340 may include at least one processor or microprocessor, or may be part of the processor. According to an example embodiment of the present disclosure, the control unit 340 may perform various functions of the control device 110 to control the air conditioning system.

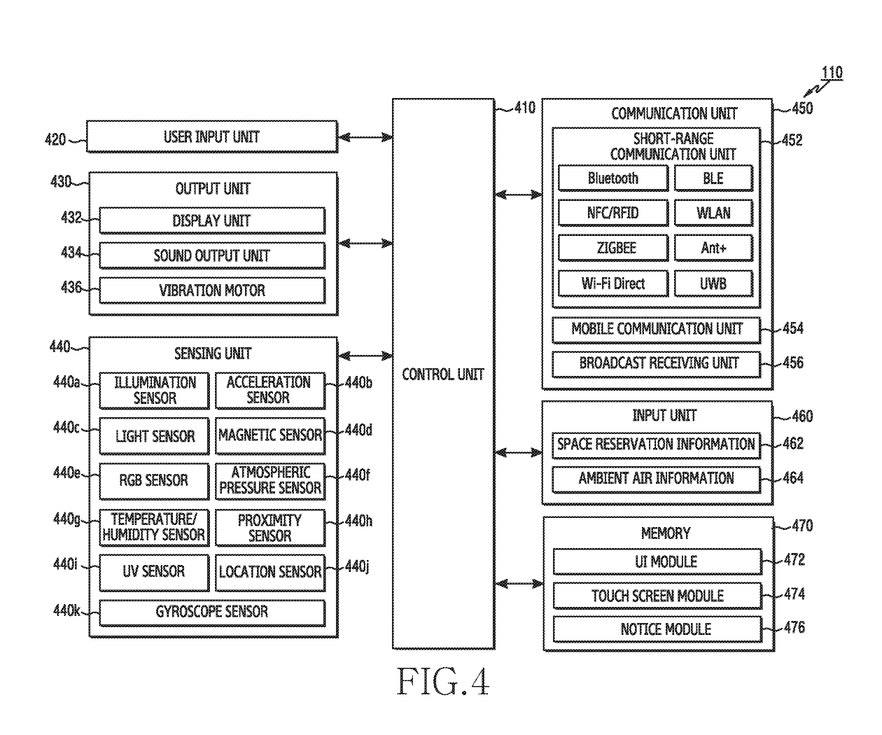

FIG. 4 is a block diagram illustrating an example control device in an air conditioning system according to another example embodiment of the present disclosure. Hereafter, terms such as parts and units indicate a unit for processing at least one function or operation, and may be implemented using hardware (e.g., circuitry), software, or a combination of hardware and software. Referring to FIG. 4, the control device 110 includes a control unit (e.g., including processing circuitry) 410, a user input unit (e.g., including input circuitry) 420, an output unit (e.g., including output circuitry) 430, a sensing unit 440, a communication unit (e.g., including communication circuitry) 450, an input unit (e.g., including input circuitry) 460, and a memory 470.

The control unit 410 may include various circuitry, including, for example, processing circuitry that control, for example, a plurality of hardware or software components connected to the control unit 410 and perform various data processing and operations by executing an Operating System (OS) or an application program. The control unit 410 may be implemented with, for example, processing circuitry, a System on Chip (SoC), or the like, but is not limited thereto. The control unit 410 may further include a Graphic Processing Unit (GPU) and/or an image signal processor. The control unit 410 may include at least part of the components of FIG. 4. The control unit 410 may load commands or data received from at least one other component (e.g., a nonvolatile memory) into a volatile memory, process them, and store various data in a nonvolatile memory.

The user input unit 420 may include various circuitry that detects a user input. For example, the user input unit 420 may include various input circuitry, such as, for example, and without limitation, a mouse, a keyboard, a microphone, a touch panel, a pen sensor, a key, or an ultrasonic input device.

The output unit 430 may include various circuitry that outputs information to the user. For example, the information may be output visually, audibly, or tactually. For example, the output unit 430 may include various output circuitry, such as, for example, and without limitation, at least one of a display unit 432, a sound output unit 434, and a vibration motor 436. The display unit 432 may include various display circuitry, such as, a panel, a hologram device, or a projector. The panel may be implemented to be, for example, flexible, transparent, or wearable. The hologram device may show three-dimensional images in the air using interference of light. The projector may show images by projecting the light onto a screen. The screen may be disposed, for example, inside or outside the control device 110. The display unit 432 may further include a control circuit for controlling the panel, the hologram device, or the projector.

The sensing unit 440 may include various circuitry that detects a change of an ambient environment or a state change of the control device 110. For example, sensing unit 440 may measure a physical quantity or detect an operating state of the control device 110, and convert the measured or detected information into an electrical signal. The sensing unit 440 may include various sensors or sensing circuitry, such as, for example, and without limitation, at least one of an illumination sensor 440a, an acceleration sensor 440b, a light sensor 440c, a magnetic sensor 440d, a Red, Green, Blue (RGB) sensor 440e, an atmospheric pressure sensor 440f, a temperature/humidity sensor 440g, a proximity sensor 440h, an Ultra Violet (UV) sensor 440i, a location sensor 440j, and a gyroscope sensor 440k.

The communication unit 450 may have the same or similar construction of the communication unit 320 of FIG. 3. The communication unit 450 may include various communication circuitry, such as, for example, and without limitation, a short-range communication unit 452, a mobile communication unit 454, and a broadcast receiving unit 456. The short-range communication unit 452 may include various communication circuitry, such as, for example, and without limitation, at least one of a Bluetooth module, a Bluetooth Low Energy (BLE) module, a Near Filed Communication (NFC)/RF Identify (RFID) module, a Wireless Local Area Network (WLAN) module, a Zigbee module, an ANT+ module, a Wireless Fidelity (WiFi) direct module, and an Ultra Wire Band (UWB) module. The mobile communication unit 454 may provide a communication function conforming to a cellular standard such as Long Term Evolution (LTE) system. For example, the mobile communication unit 454 may provide a voice call, a video call, a text service, or an Internet service over a cellular network. Although not depicted in FIG. 4, the communication unit 450 may further include an RF module.

The input unit 460 may include various input circuitry that receives information other devices of the air conditioning system, an external device, or the user. For example, the information may include space reservation information 462 and ambient air information 464. When the space reservation information 462 and the ambient air information 464 are received through the communication unit 450, the input unit 460 may be omitted.

The memory 470 may include, for example, an internal memory and an external memory. The memory 470 may include at least one of a volatile memory (e.g., Dynamic RAM (DRAM), Static RAM (SRAM), or Synchronous Dynamic RAM (SDRAM)), and a non-volatile memory (e.g., One Time Programmable ROM (OTPROM), Programmable ROM (PROM), Erasable and Programmable ROM (EPROM), Electrically Erasable and Programmable ROM (EEPROM), mask ROM, flash ROM, flash memory (e.g., NAND flash or NOR flash), hard drive, and solid state drive (SSD)). The memory 470 may store various software components. For example, the memory 470 may store a User Interface (UI) module 472, a touch screen module 474, and a notice module 476.

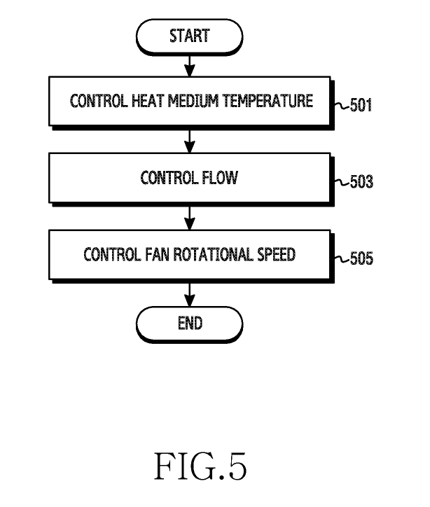

FIG. 5 is a flowchart illustrating example operations of a control device in an air conditioning system according to an example embodiment of the present disclosure. FIG. 5 illustrates an example operating method of the control device 110.

Referring to FIG. 5, the control device controls a temperature of a heat medium in operation 501. The control device may determine the temperature of the heat medium supplied into spaces along pipes based on information about spaces and an outdoor environment of the building. For example, the outdoor environment information indicates conditions outside the building not affected by the indoor condition of the building. For example, the outdoor environment information may include at least one of an ambient air temperature, a rainfall, a snowfall, an air speed, a wind direction, an insolation, and an outdoor humidity. For example, the temperature of the heat medium may be determined by predefined mapping information. For example, the control device may retrieve the temperature corresponding to at least one of a maximum insolation, a vacancy rate of the spaces, and a use pattern of the spaces from the predefined mapping information. Herein, the vacancy rate may indicate a rate of vacant spaces (e.g., rooms) received from a management server (e.g., the management device 120) of the building (e.g., a hotel). Herein, the use pattern of the spaces may be determined based on a section corresponding to a weight sum of the number of one or more spaces which are occupied or reserved among the spaces. For example, the temperature of the heat medium may be determined by gradually increasing or decreasing based on a temperature change of at least one of the spaces. For example, when a difference of a measured temperature change rate and a target temperature change rate exceeds an allowable range, the control device may increase or decrease the temperature of the heat medium by one degree.

In operation 503, the control device controls a flow of the heat medium. For example, the control device controls a flow rate of the heat medium. The control device may determine the flow of the heat medium supplied into the spaces along the pipes based on the information about the spaces and the outdoor environment of the building. For example, the flow of the heat medium may be determined by the predefined mapping information. For example, the control device may retrieve a velocity value corresponding to a difference of the target temperature change rate and the measured temperature rate from the predefined mapping information.

In operation 505, the control device controls a rotational speed of a fan. The control device may determine the rotational speed of the fans installed in the spaces based on the temperature change of the spaces. The rotational speed of the fans may be determined by the predefined mapping information.

Although not illustrated in FIG. 5, the control device may send a signal for controlling at least one of the temperature and the flow of the heating medium, and the rotational speed. For example, the signal may be transmitted to the cooling/heating control device 130 or the air conditioning devices 150-1 through 150-N.

In FIG. 5, the temperature of the heat medium, the flow of the material, and the air speed may be controlled in this order. While the present disclosure is not limited to the temperature, the flow, and the air speed in this order, the order of the temperature, the flow, and the air speed may improve energy reduction. For example, the order of the temperature, the flow, and the air speed is based on an energy consumed for the control. The control device may first determine the temperature which consumes the greatest energy, control the flow, and then control the air speed which consumes the least energy.

Further, the temperature, the flow, and the air speed may be controlled periodically at different time intervals. For example, the temperature may be controlled at a longer interval than the flow, and the flow may be controlled at a longer interval than the air speed. For example, the temperature may be controlled once every daytime and every night, the flow may be controlled every hour, and the air sped may be controlled every 30 minutes.

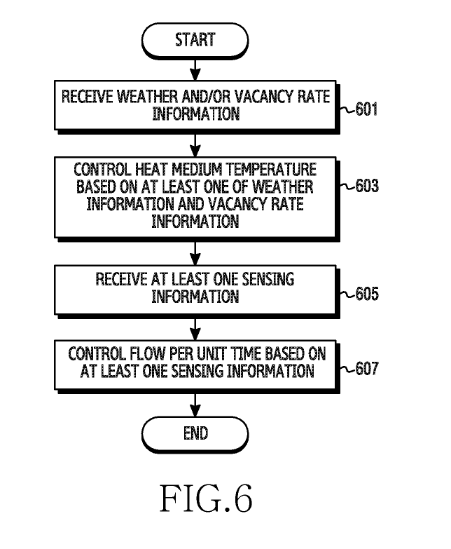

FIG. 6 is a flowchart illustrating example operations of a control device in an air conditioning system according to another example embodiment of the present disclosure. FIG. 6 illustrates an example operating method of the control device 110.

Referring to FIG. 6, in operation 601, the control device receives weather or vacancy rate information. For example, the weather may be information announced by predicting changes in weather using a weather map and other meteorological equipment in a weather center or other private agencies, and may be expressed numerically. For example, the weather may include information about at least one of conditions (e.g., clear, cloudy, rainy, etc.), the temperature, the rainfall, the snowfall, the wind, the insolation, and the humidity. The vacancy rate may, for example, indicate a rate of vacant spaces (e.g., rooms) received from a management server (e.g., the management device 120) of a building (e.g., hotel). For example, the vacancy rate is opposite information of the reservation rate, and the vacancy rate information may be replaced by the reservation rate information.

In operation 603, the control device controls the temperature of the heat medium based on at least one of the weather information and the vacancy rate information. For example, the temperature of the heat medium may be determined by the predefined mapping information. For example, the control device may retrieve the temperature corresponding to at least one of the weather and the vacancy rate from the predefined mapping information. The use pattern of the spaces may be further used to control the temperature of the heat medium.

In operation 605, the control device receives at least one sensing information. The sensing information may be measured by a sensor and may include information measured inside the building or information measured outside the building. For example, the sensing information may include at least one of the indoor temperature, the ambient temperature, the insolation, the occupancy rate, and the humidity.

In operation 607, the control device controls the flow per unit time, for example, a flow velocity based on the at least one sensing information. For example, the control device may determine the flow of the heat medium based on at least one of the indoor temperature, the ambient temperature, the insolation, the occupancy rate, and the humidity. The control device may send a signal for controlling to supply the heat medium of the determined flow along the pipes. For example, the flow of the heat medium may be determined by the predefined mapping information. For example, the control device may retrieve a flow value or a flow rate corresponding to the at least one sensing information from the predefined mapping information.

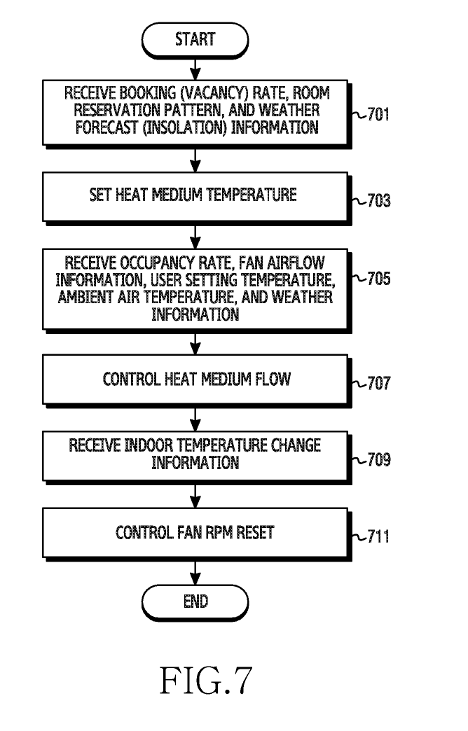

FIG. 7 is a flowchart illustrating example operations of a control device in an air conditioning system according to an example embodiment of the present disclosure. FIG. 7 illustrates an example operating method of the control device 110.

Referring to FIG. 7, in operation 701, the control device receives information of a reservation rate or a vacancy rate of spaces, a reservation pattern, and a weather forecast (e.g., insolation). The reservation pattern may be determined by an orientation and a shape of at least one reserved space. The weather may be information announced by predicting changes in weather using a weather map and other meteorological equipment in a weather center or other private agencies, and may be expressed numerically. For example, the weather may include information about at least one of conditions (e.g., clear, cloudy, rainy, etc.), the temperature, the rainfall, the snowfall, the wind, the insolation, and the humidity.

In operation 703, the control device sets a temperature of a heat medium. For doing, the control device may control a refrigerator or a boiler of a cooling/heating control device (e.g., the cooling/heating control device 130). When the temperature is set, the flow and the fan RPM may be set by default. For the temperature setting, a current temperature of the heat medium may be required. In this example, to obtain the temperature of the heat medium, the control device may use load calculation, a simulation, continual updating from machine learning, or manager know-now. The load calculation is based on a predefined calculation formula, and the calculation formula may be determined based on a required load in a design phase. Based on the manager know-how, the temperature of the heat medium may be managed using a table and may be continually updated.

In operation 705, the control device receives information of an occupancy rate, a fan airflow, a user setting temperature, an ambient temperature, and weather. The occupancy rate may include the number of users in the building against the number of reservation persons. The occupancy rate may be determined based on sensor or cardkey information, or a pre-scheduled occupancy rate may be applied. The fan airflow may be set to, for example, high/mid/low/off by the user of each space. The user setting temperature may indicate, for example, a desired indoor temperature input by the user of each space or the building manager through a temperature control device of each space or a central control device. The ambient temperature or weather information may be obtained over an external communication network. For example, the ambient temperature or weather information may be obtained from a weather center server.

In operation 707, the control device controls the flow of the heat medium. For doing so, the control device may control a pump of a cooling/heating control device (e.g., the cooling/heating control device 130). To determine an adequate flow, the control device may generate secondary information (e.g., a temperature difference, an insolation difference, etc.) based on the information received in operation 705. For example, the temperature difference may include a difference of a current temperature and the user setting temperature, a difference of a predicted comfortable temperature and the user setting temperature, and a difference of a current ambient temperature and a predicted ambient temperature. An insolation difference may include a difference of a current insolation and a predicted insolation.

In operation 709, the control device receives indoor temperature change information. The indoor temperature change information may include at least one of a difference of temperature change rate, a temperature change rate, a target temperature change rate, and an actual temperature change rate. The difference of the temperature change rate may include a difference of the target temperature change rate and the actual temperature change rate. The temperature change rate may include a temperature which changes per unit time (e.g., minute). The target temperature change rate may include a value obtainable in each building according to fan conditions, the indoor temperature of the space, and the temperature of the heat medium. The actual temperature change rate may be measured by a sensor.

In operation 711, the control device controls the RPM of the fan. The fan RPM determines the air speed. That is, the air speed may reset a user sensible temperature in the space. For example, an air speed change of 0.2 m/s may compensate for about 2° C.

In FIG. 7, the temperature of the heat medium may be controlled by the pre-obtainable information such as reservation rate and weather, and the flow of the heat medium may be controlled by the realtime-varying information such as current occupancy rate or user setting. This is because the temperature change requires a certain time, and it is easier to immediately change the flow than the temperature. For example, the control device may set the temperature of the heat medium based on an information item (e.g., the reservation rate) which may be obtained in advance and does not change easily. Since the occupancy rate is variable, the control device controls the energy supply to the building by changing the flow according to a situation. Hence, although the vacancy rate is low, when many occupants leave the space to decrease the occupancy rate, the supply energy per time may reduce.

In FIG. 7, the control factors may be controlled in order of the heat medium temperature, the heat medium flow, and the fan speed. Such an order is defined based on an ability of the real-time change and a significance for an energy consumption. Hence, when planning the air conditioning, the control device sets the item which does not easily change and greatly affects the energy consumption, for example, the temperature to an adequate degree based on the known information (e.g., the reservation rate).

The temperature, the flow, the fan rotational speed may be controlled in various manners. According to an example embodiment, the temperature, the flow, the fan rotational speed may be controlled by predefined tables. At least one table set may be defined for one building, and the tables may define the temperature, the flow, the fan rotational speed corresponding to a given situation. Examples of the table set are illustrated in Table 1 through Table 9.

Table 1, Table 2, and Table 3 illustrate criteria for determining the temperature of the heat medium. Table 1 arranges the temperature of the heat medium based on the insolation, the vacancy rate, and the space reservation pattern, with the insolation 1000 mWh/m².

TABLE 1

| Maximum | Reservation rate | space | temperature of the | |
|---|---|---|---|---|
| Insolation | (Vacancy rate) | reservation | heat medium [° C.] | |
| [kWh/m²] | [%] | pattern | Day time | Night time |
| 1000 | 25 | P1 | 16 | 17 |
| | | P2 | 15 | 16 |
| | | P3 | 14 | 15 |
| | | P4 | 13 | 14 |
| | 50 | P1 | 16 | 16 |
| | | P2 | 14 | 15 |
| | | P3 | 13 | 14 |
| | | P4 | 12 | 13 |
| | 75 | P1 | 14 | 15 |
| | | P2 | 13 | 14 |
| | | P3 | 12 | 13 |
| | | P4 | 11 | 12 |
| | 100 | P1 | 13 | 14 |
| | | P2 | 12 | 13 |
| | | P3 | 11 | 12 |
| | | P4 | 10 | 11 |

In Table 1, the reservation rate is opposite to the vacancy rate, and ‘vacancy rate—1’ corresponds to ‘reservation rate’. Since both rates indicate a substantially similar meaning, they may be interchanged. It is noted that the vacancy rate is the complement of the reservation rate. Accordingly, when the vacancy rate is used, the rates of Table 1 change from 25, 50, 75, 100 to 75, 50, 25, 0.

Table 2 arranges the temperature of the heat medium based on the insolation, the vacancy rate, and the space reservation pattern, with the insolation 1500 mWh/m².

TABLE 2

| Maximum | Reservation rate | space | temperature of the | |
|---|---|---|---|---|
| Insolation | (Vacancy rate) | reservation | heat medium [° C.] | |
| [kWh/m²] | [%] | pattern | Day time | Night time |
| 1500 | 25 | P1 | 15 | 16 |
| | | P2 | 14 | 15 |
| | | P3 | 13 | 14 |
| | | P4 | 12 | 13 |
| | 50 | P1 | 14 | 15 |
| | | P2 | 13 | 14 |
| | | P3 | 12 | 13 |
| | | P4 | 11 | 12 |
| | 75 | P1 | 13 | 14 |
| | | P2 | 12 | 13 |
| | | P3 | 11 | 12 |
| | | P4 | 10 | 11 |
| | 100 | P1 | 12 | 13 |
| | | P2 | 11 | 12 |
| | | P3 | 10 | 11 |
| | | P4 | 9 | 10 |

Table 3 arranges the temperature of the heat medium based on the insolation, the vacancy rate, and the space reservation pattern, with the insolation 2000 mWh/m².

TABLE 3

| Maximum | Reservation rate | space | temperature of the | |
|---|---|---|---|---|
| Insolation | (Vacancy rate) | reservation | heat medium [° C.] | |
| [kWh/m²] | [%] | pattern | Day time | Night time |
| 2000 | 25 | P1 | 14 | 15 |
| | | P2 | 13 | 14 |
| | | P3 | 12 | 13 |
| | | P4 | 11 | 12 |
| | 50 | P1 | 13 | 14 |
| | | P2 | 12 | 13 |
| | | P3 | 11 | 12 |
| | | P4 | 10 | 11 |
| | 75 | P1 | 12 | 13 |
| | | P2 | 11 | 12 |
| | | P3 | 10 | 11 |
| | | P4 | 9 | 10 |
| | 100 | P1 | 11 | 12 |
| | | P2 | 10 | 11 |
| | | P3 | 9 | 10 |
| | | P4 | 8 | 9 |

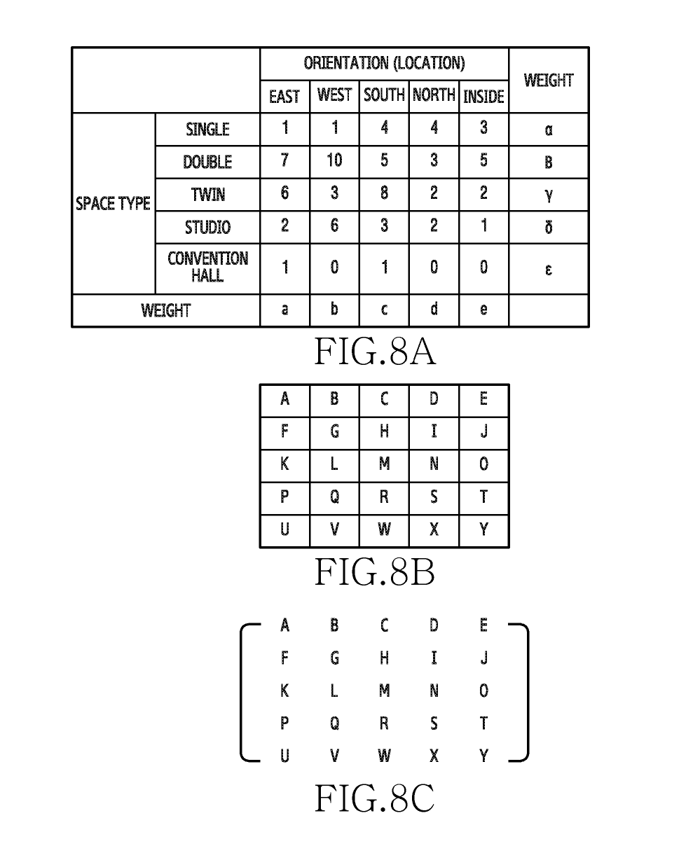

In Table 1, Table 2, and Table 3, the maximum insolation (sunshine) is obtained from the weather forecast. The reservation rate (vacancy rate) may be the rate of the occupied spaces against all of the spaces and may be provided from the management device 120. The space reservation pattern may be defined based on a location, an orientation, and a type of the reserved, for example, occupied spaces, and may be generated from the reservation information. The space reservation pattern may be referred to as a space use pattern. For example, the space reservation pattern may be defined as illustrated in FIGS. 8A-8C.

FIGS. 8A, 8B and 8C depict a space reservation pattern determined in an air conditioning system according to an example embodiment of the present disclosure. In FIGS. 8A-8C, the space reservation pattern is determined by applying a weight based on a space type and a space location.

Referring to FIG. 8A, the space type may be divided into single, double, twin, studio, and convention hall. For example, the type is classified by considering, but not limited to, accommodations such as hotel in FIG. 8. However, the space type may be classified according to a purpose of the building. The location of the space is divided into east, west, south, north, and inside. The east, west, south, and north may be applied to spaces in a certain number or in a certain range near an outer wall, that is, from the outer wall. The east, west, south, and north are divided according to a relative orientation based on a center of the building. Other spaces than the east, west, south, and north spaces may be classified to the inside.

The number of the reserved or occupied spaces of the corresponding location and type is counted. The reserved or occupied spaces may be counted based on the reservation information provided from the management device 120 or the sensing information measured in each space. As illustrated in FIG. 8A, once single space is located in the east, one single space is located in the west, four single spaces are located in the south, four single spaces are located in the north, three single spaces are located in the inside, seven double spaces are located in the east, ten double spaces are located in the west, five double spaces are located in the south, three double spaces are located in the north, five double spaces are located in the inside, six twin spaces are located in the east, three twin spaces are located in the west, eight twin spaces are located in the south, two twin spaces are located in the north, two twin spaces are located in the inside, two studio spaces are located in the east, six studio spaces are located in the west, three studio spaces are located in the south, two spaces are located in the north, one studio space is located in the inside, one conventional hall is located in the east, no conventional hall is located in the west, one conventional hall is located in the south, no conventional hall is located in the north, and no conventional hall is located in the inside. The weight of the corresponding location and type may be applied to each counting value.

The weighted counting values may form a pattern table as illustrated in FIG. 8B, Further, the weighted counting values may form a matrix as illustrated in FIG. 8C. For example, in FIGS. 8B and 8C, A is 1×α×a and S is 2×δ×d.

The pattern of FIGS. 8A-8C is divided into P1, P2, P3, and P4 as defined in Table 1, Table 2, and Table 3. Various mapping methods may be applied according to various example embodiments. According to an example embodiment, a sum of elements of the matrix may be used. When the table or matrix elements are determined as illustrated in FIG. 8B or FIG. 8C, the sum of the elements may be expressed as one metric (e.g., number). P1, P2, P3, and P4 correspond to ranges of different metrics. Hence, depending on the range of the determined sum of the elements, the space reservation pattern is classified to one of P1, P2, P3, and P4.

When the temperature of the heat medium is determined based on Table 1, Table 2, and Table 3, the control device 110 may determine the maximum insolation, the vacancy rate, and the space reservation pattern, and then retrieves the temperature corresponding to the determined maximum insolation, vacancy rate, and space reservation pattern. For example, when the maximum insolation is 1500 kWh/m², the vacancy rate is 50%, the space reservation pattern is P2, and the determination is made in the daytime, the temperature may be set to 13° C.

Table 4 through Table 8 illustrate various criteria for determining the temperature of the heat medium. Table 4 illustrates a flow rate of the heat medium based on the occupancy rate.

TABLE 4

| Occupancy rate | Flow rate of the |
|---|---|
| [%] | heat medium |
| below 10% | 0.1 |
| 20% | 0.2 |
| 30% | 0.3 |
| 40% | 0.4 |
| 50% | 0.5 |
| 60% | 0.6 |
| 70% | 0.7 |
| 80% | 0.8 |
| 90% | 0.9 |
| 100% | 1.0 |
| 110% | 1.1 |
| above 110% | 1.2 |

Table 5 illustrates a flow rate of the heat medium based on the fan condition.

TABLE 5

| Fan condition | Flow rate of the |
|---|---|
| [%] | heat medium |
| 0% | 1.00 |
| 10% | 1.05 |
| 20% | 1.10 |
| 30% | 1.15 |
| 40% | 1.20 |
| 50% | 1.25 |
| 60% | 1.30 |
| 70% | 1.35 |
| 80% | 1.40 |
| 90% | 1.45 |
| 100% | 1.50 |

Table 6 illustrates a flow rate of the heat medium based on the difference of the current temperature and the setting temperature.

TABLE 6

| Difference of the current | |
|---|---|
| temperature and the setting | Flow rate of the |
| temperature [° C.] | heat medium |
| −1 | 1.0 |
| 0 | 1.0 |
| 1 | 1.0 |
| 3 | 1.1 |
| 5 | 1.2 |
| 7 | 1.3 |
| 9 | 1.4 |
| 11 | 1.5 |
| 13 | 1.6 |
| 15 | 1.7 |
| 17 | 1.8 |

Table 7 illustrates a flow rate of the heat medium based on a difference of the current ambient temperature and the predicted ambient temperature.

TABLE 7

| Difference of the current ambient | |
|---|---|
| temperature and the predicted | Flow rate of the |
| ambient temperature [° C.] | heat medium |
| −1 | 1.00 |
| 0 | 1.00 |
| 1 | 1.00 |
| 3 | 1.01 |
| 5 | 1.02 |
| 7 | 1.03 |
| 9 | 1.04 |
| 11 | 1.05 |
| 13 | 1.06 |
| 15 | 1.07 |
| 17 | 1.08 |

Table 8 illustrates a flow rate of the heat medium based on the difference of the current insolation and the predicted insolation.

TABLE 8

| Difference of the current | |
|---|---|
| insolation and the predicted | Flow rate of the |
| insolation [kWh/m2] | heat medium |
| −1000 | 0.5 |
| −800 | 0.6 |
| −600 | 0.7 |
| −400 | 0.8 |
| −200 | 0.9 |
| 0 | 1.0 |
| 200 | 1.1 |
| 400 | 1.2 |
| 600 | 1.3 |
| 800 | 1.4 |
| 1000 | 1.5 |

The flow of the heat medium may be determined based on Table 4 through Table 8. Table 4 through Table 8 may, for example, define the flow as the rate. For example, a default value of the flow may be predefined and the rate adjusted based on status information. For example, when the selected rate is 1.0, the default value of the flow may be applied.

Table 4 through Table 8 suggest five criteria. All or some of the five criteria may be selectively used based on an intention of an executor. When a plurality of criteria is applied, a plurality of rates may be determined based on each information item (e.g., occupancy rate, fan condition, etc.). In this example, a final flow rate may be set to a product or an average of the determined rates. Different weights per information item may be applied to the final average. Further, the weight may change per time zone. For example, when the product of the rates is determined as the final rate, the occupancy rate is 40%, the fan condition is 60%, the difference of the current temperature and the setting temperature is 5° C., the difference of the current ambient temperature and the predicted ambient temperature is 0° C., the difference of the current insolation and the predicted insolation is 400 kWh/m², and the default flow value is 2 m³/s, the final flow may be set to 1.49 m³/s. Besides, a combination of the flow values may be applied in various manners.

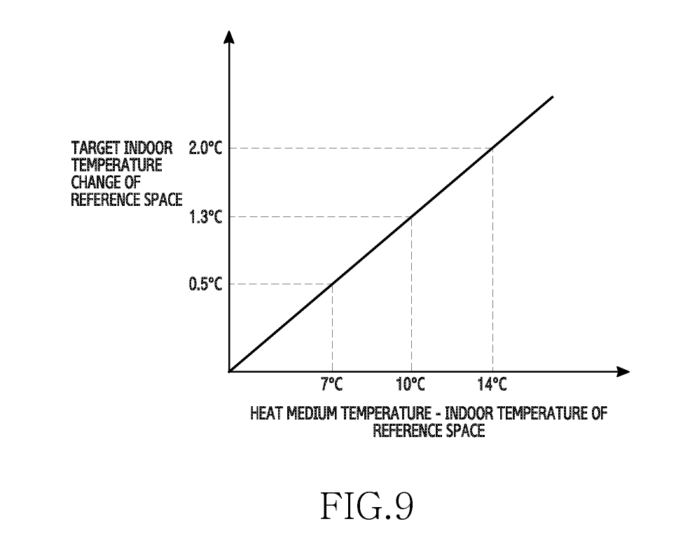

FIG. 9 illustrates the fan rotational speed based on the difference of the temperature change rate.

TABLE 9

| Difference of the temperature | Fan rotational speed [rpm] | | |
|---|---|---|---|
| change rate [° C./min] | High | Middle | Low |
| −1 | 1050 | 830 | 510 |
| 0 | 1000 | 800 | 500 |
| 1 | 1050 | 830 | 510 |
| 2 | 1100 | 860 | 520 |
| 3 | 1150 | 890 | 530 |
| 4 | 1200 | 820 | 540 |
| 5 | 1250 | 850 | 550 |
| 6 | 1300 | 890 | 560 |
| 7 | 1350 | 1010 | 570 |

Table 9 defines the rotational speed corresponding to high, mid, and low of the fan setting based on the difference of the temperature change rate. For example, the difference of the temperature change rate may indicate the difference of the target temperature change rate and the actual temperature change rate. The actual temperature change rate may be measured in one space selected as a reference space from the multiple spaces. The target temperature change rate may be determined based on the fan condition, the current indoor temperature, and the temperature of the heat medium. For example, the target temperature change rate may be defined as illustrated in FIG. 9. FIG. 9 depicts the target temperate change rate in an air conditioning system according to an example embodiment of the present disclosure. Referring to FIG. 9, a horizontal axis indicates the difference between the temperature of the heat medium and the indoor temperature of the reference space, and a vertical axis indicates the target indoor temperature change, for example, the target temperature change rate. As illustrated in FIG. 9, the target temperature change rate varies based on the difference between the current temperature of the heat medium and the indoor temperature of the reference space. Hence, the control device 110 may store the data of FIG. 9 in a table, determine the difference between the current temperature of the heat medium and the indoor temperature of the reference space, and determine the target temperature change rate corresponding to the difference.

In Table 9, the rotational speed of the fan is controlled based on the difference of the temperature change rate. Accordingly, the rotational speed of the fan may be controlled to reduce the difference of the actual temperature change rate and the target temperature change rate. For example, the rotational speed of the fan may be increased to accelerate the change difference as the difference of the actual temperature change rate and the target temperature change rate increases. As a result, frequent temperature changes of the heat medium may be prevented and/or reduced.

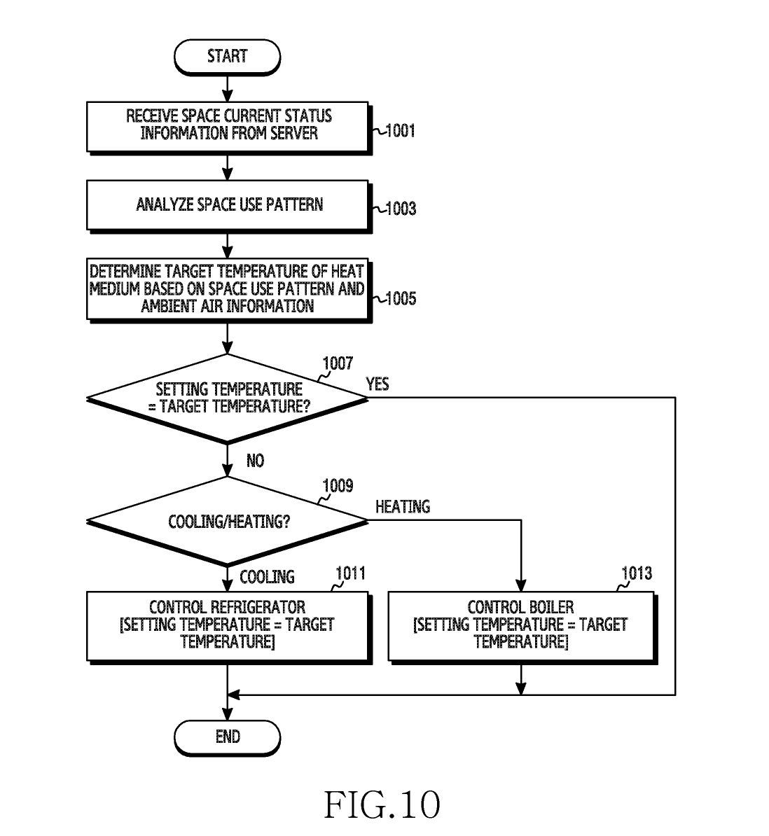

As such, the control device 110 may control the indoor temperature of the building by controlling the temperature of the heat medium, the flow of the heat medium, and the rotational speed of the fan installed in the spaces. In the above-mentioned example embodiments, the controlling may be executed based on the predefined tables. According to other example embodiments, adaptive control based on real-time monitoring, rather than the tables, is also feasible. Now, the temperature of the heat medium is controlled as illustrated in FIGS. 10, 11, and 12.

FIG. 10 is a flowchart illustrating an example method for controlling a temperature in an air conditioning system according to an example embodiment of the present disclosure. FIG. 10 illustrates an example operating method of the control device 110.

Referring to FIG. 10, the control device receives space current status information from a server in operation 1001. Herein, the server may refer, for example, to a device which stores and manages use or reservation information of spaces in a building. For example, the server may be the management device 120 of FIG. 1.

In operation 1003, the control device analyzes the space use pattern. The space use pattern is classified based on the location, the orientation, and the type of the spaces. The location may be divided into east, west, south, north, and inside. For example, the control device may count the occupied or reserved spaces based on the location and the type, apply the corresponding weight, and thus determine at least one metric for the whole space. The control device may confirm a section of the metric, confirm a pattern value corresponding to the section, and thus determine the current space use pattern.

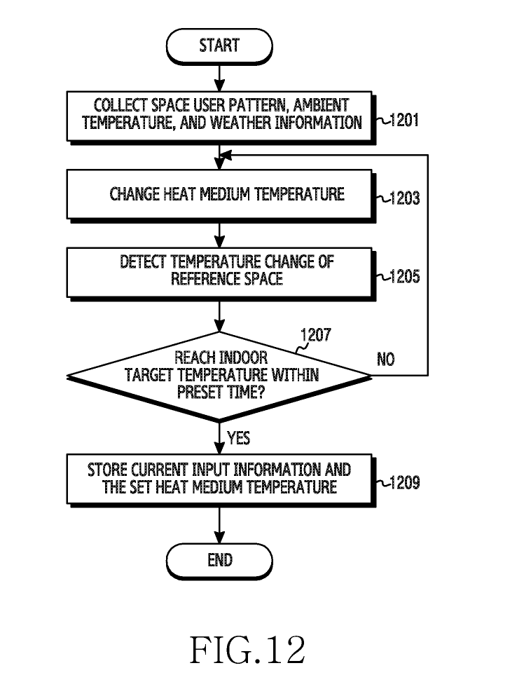

In operation 1005, the control device determines the target temperature of the heat medium based on the space use pattern and the ambient air information. For doing so, the control device may monitor the temperature change of the reference space and adaptively control the target temperature of the heat medium. Determining the target temperature will be described in greater detail below with reference to FIG. 12.

In operation 1007, the control device compares the current setting temperature and the target temperature in the inside. When the current setting temperature is the same as the target temperature, the control device finishes this process. When the current setting temperature is different from the target temperature, the control device goes to operation 1009.

In operation 1009, the control device determines which of cooling and heating is required. Which of the cooling and the heating is required may be determined based on a current season, the ambient temperature, and the setting of the space. When cooling is required, the control device goes to operation 1011. When heating is required, the control device goes to operation 1013.

In operation 1011, the control device controls a refrigerator. The control device controls the refrigerator such that the setting temperature reaches the target temperature. For example, the control device performs a control to lower the temperature of the heat medium. For doing so, the control device may control the cooling/heating control device 130 of FIG. 1. For example, the control device may send to the cooling/heating control device 130 of FIG. 1 a signal instructing to lower the temperature.

In operation 1013, the control device controls a boiler. The control device controls the boiler such that the setting temperature reaches the target temperature. For example, the control device performs a control to increase the temperature of the heat medium. For doing so, the control device may control the cooling/heating control device 130 of FIG. 1. For example, the control device may send to the cooling/heating control device 130 of FIG. 1 a signal instructing to increase the temperature.

FIG. 10 illustrates a method for adaptively controlling the temperature of the heat medium. It is noted that a similar method may be executed when predefined tables are used. In this example, the control device may determine the target temperature of the heat medium based on Table 1, Table 2, and Table 3 in operation 1005.

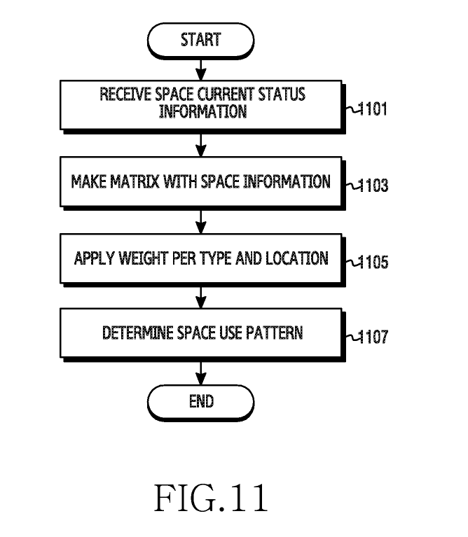

FIG. 11 is a flowchart illustrating an example method for determining a space use pattern in an air conditioning system according to an example embodiment of the present disclosure. FIG. 11 illustrates an example operating method of the control device 110. FIG. 11 is a flowchart illustrating operation 903 of FIG. 9.

Referring to FIG. 11, in operation 1101, the control device receives space current status information. The space current status information may be received from a device which stores and manages use or reservation information of spaces in a building. For example, the space current status information may be received from the management device 120 of FIG. 1.

In operation 1103, the control device makes (generates) a matrix with space information. The control device identifies types and locations of the occupied or reserved spaces based on the space current status information, counts the spaces per type and location, and forms the matrix including the counting values as elements. For example, the matrix may be constructed as illustrated in FIG. 8A.

In operation 1105, the control device applies the weight per type and the location. Each element of the matrix corresponds to a combination of different type and location. Different weights may be defined based on the type and the location. Hence, the control device applies the weight to each counting value. For example, the weighted results are illustrated in FIG. 8B or FIG. 8C.

In operation 1107, the control device determines the space use pattern. The space use pattern may be defined variously. According to an example embodiment, the space use pattern may be divided to n-array representative values such as P1, P2, . . . , Pn. In this example, the control device may determine at least one metric by, for example, summing the element values of the weighted matrix, confirm the representative value corresponding to a range of the metric, and thus determine the space use pattern.

FIG. 12 is a flowchart illustrating an example method for determining a space use pattern in an air conditioning system according to an example embodiment of the present disclosure. FIG. 12 illustrates an example operating method of the control device 110. FIG. 12 is a flowchart illustrating operation 905 of FIG. 9.

Referring to FIG. 12, in operation 1201, the control device collects space use pattern, the ambient temperature, and the weather information. The space use pattern may be determined as illustrated in FIG. 11. The ambient temperature may be determined by actual measurement. The weather information may be obtained from a weather center server. For example, the control device may determine the space use patterns based on the locations and the types of the occupied or reserved spaces, measure the ambient temperature using a sensor, and collect the weather information from an external server (e.g., a weather center server).

In operation 1203, the control device changes the temperature of the heat medium. Initially, the control device may set the temperature of the heat medium to a reference value. Next, the control device may adaptively change the temperature of the heat medium by repeating operations 1205 and 1207. After the operation 1207, the control device may set the temperature of the heat medium to a different value from the reference value. For example, the control device may increase or decrease the temperature of the heat medium by a preset value.

In operation 1205, the control device detects a temperature change of the reference space. For example, the control device determines whether the temperature of the reference space changes and how much the temperature of the reference space changes. The temperature change of the reference space may be measured by an air conditioning device or a separate sensor installed in the reference space and then provided to the control device. The control device may periodically detect the temperature change of the reference space at certain time intervals.

In operation 1207, the control device determines whether the temperature of the reference space reaches the target indoor temperature within a preset time. When the temperature of the reference space does not reach the target indoor temperature within the preset time, the control device returns to the operation 1203. When the temperature of the reference space reaches the target indoor temperature within the preset time, the control device proceeds to operation 1209.

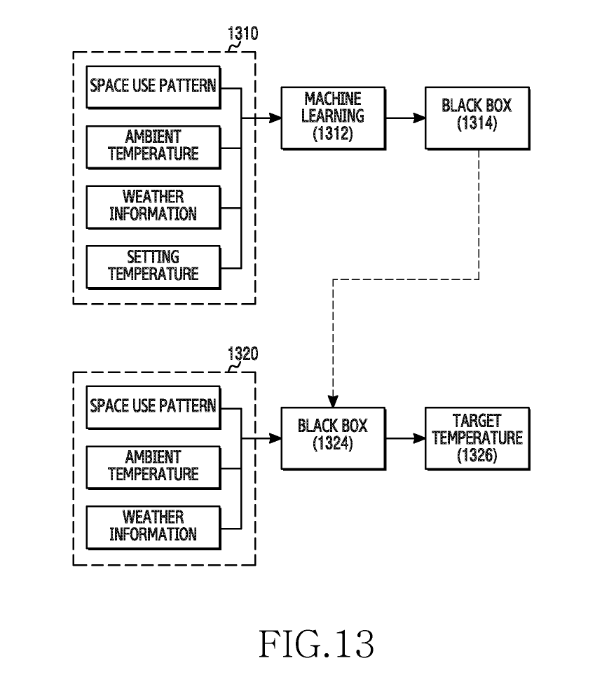

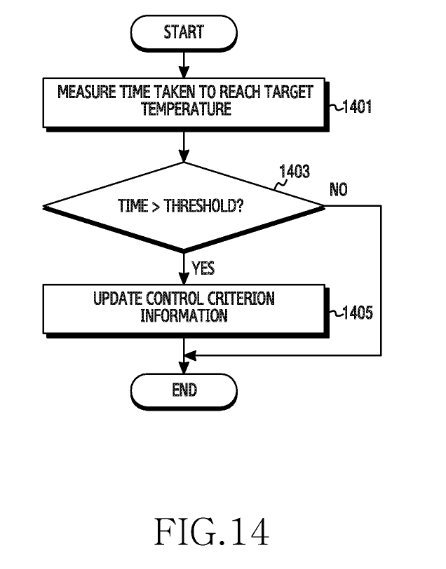

In operation 1209, the control device stores current input information and the set heat medium temperature. The operation 1209 may, for example, be used for machine learning. The information collected in the operation 1201 may be also stored for the machine learning. The machine learning shall be described in greater detail below with reference to FIG. 13 and FIG. 14. When the machine learning is not considered, operation 1209 may be omitted.

The air conditioning system may control the indoor temperature by considering the building status and the outdoor environment. The indoor temperature is controlled by regulating the temperature of the heat medium, the flow of the heat medium, and the rotational speed of the indoor fan. In so doing, the control factors of the temperature of the heat medium, the flow of the heat medium, and the rotational speed of the indoor fan may be optimized and/or improved through learning. For example, the control factors may be updated based on statistics of past control. Herein, such a process may be referred to as machine learning, which is now explained in greater detail below with reference to FIG. 13.

FIG. 13 is a diagram illustrating an example concept of machine learning in an air conditioning system according to an example embodiment of the present disclosure. Referring to FIG. 13, machine learning 1312 may, for example, be conducted based on past input information 1310. The past input information 1310 may include, for example, the space use pattern, the ambient temperature, the weather information, and the setting temperature.

A result of the machine learning 1312 may, for example, be stored in a black box 1314. The machine learning 1312 may determine control factor values (e.g., the temperature of the heat medium, the flow of the heat medium, and the rotational speed of the indoor fan) which may quickly reach the setting temperature under a given condition. The black box 1314, which is the storage, may be referred to as a storage unit.

For example, when the tables of Table 1 through Table 9 are used, the control factor values defined by the tables may be updated. When the method based on real-time monitoring such as that illustrated in FIG. 12 is used, the temperature change may be updated. Separately from the tables of Table 1 through Table 9, the control factor values (e.g., the temperature of the heat medium, the flow of the heat medium, and the rotational speed of the indoor fan) corresponding to various environment information (e.g., the space use pattern, the ambient temperature, the weather information, the setting temperature) may be defined. For example, the black box 1314 may store a correlation of a feed water temperature based on various environment information using the machine learning. For example, when the space use pattern is ‘a’, the ambient temperature is ‘b’, and the heat medium temperature is ‘c’ through the learning, the relation “a+b→c” is recorded in the black box 1314. When information of the space use pattern and the ambient temperature is input, the feed water temperature value may be obtained.

The information of the result of the machine learning 1312 stored in the black box 1314 is provided to a black box 1324. When new input information 1320 is input, an updated target temperature 1326 may be provided according to the result of the machine learning 1312 stored in the black box 1324. The black box 1314 and the black box 1324 may be implemented in the same storage device.

An example of the temperature control based on the real-time monitoring and the machine learning is as follows. Hereafter, it is assumed that the reference temperature is 10° C., a temperature change measurement period is one minute, an initial temperature of the reference space is 24° C., the temperature increase is 1° C., and an initial target temperature change is 2° C., in case of the cooling.

Initially, the control device 110 sets the temperature of the heat medium to the reference temperature 10° C. Since the current reference space temperature is 24° C., a difference of the heat medium temperature and the reference space indoor temperature is 14° C. and the target temperature change is 2° C. as illustrated in FIG. 9. Next, the control device 110 measures the temperature change of the reference space every minute. When the measured temperature of the reference space is assumed to be 2° C., the temperature change is 3° C. The measured change 3° C. is greater than the target temperature change 2° C. Hence, the control device 110 increases the temperature of the heat medium by 1° C. As a result, the difference between the temperature of the heat medium and the indoor temperature of the reference space is 10° C. (=21−11), and the target temperature change is 1.3° C. as illustrated in FIG. 9.

After one minute, the control device 110 measures the temperature change of the reference space. It is assumed that the measured temperature of the reference space is 19° C. In this case, the temperature change is 2° C. The measured change 2° C. is greater than the target temperature change 1.3° C. Hence, the control device 110 increases the temperature of the heat medium by 1° C. As a result, the difference between the temperature of the heat medium and the indoor temperature of the reference space is 7° C. (=19−12), and the target temperature change is 0.5° C. as illustrated in FIG. 9.

After one more minute, the control device 110 measures the temperature change of the reference space. It is assumed that the measured temperature of the reference space is 18.8° C. In this case, the temperature change is 0.2° C. The measured change 0.2° C. is smaller than the target temperature change 0.5° C. Hence, the control device 110 maintains the temperature of the heat medium. For the machine learning, the control device 110 stores the current ambient temperature, the weather (weather condition), the space use current status, and the cooling/heating water temperature in a database.

When the difference between the temperature change of the reference signal and the target temperature change is smaller than an allowable range in next measurement, the control device 110 decreases the feed water temperature by 1° C. The control device 110 compares the temperature change of the reference signal with the target temperature change every minute, and controls the temperature of the heat medium. When the difference between the temperature change of the reference signal and the target temperature change falls within the allowable range, the control device 110 keeps storing corresponding data.

As such, the temperature of the heat medium for the air conditioning of the building may be set and managed. For example, when a black box model obtained through the machine learning is stored and new input information (e.g., ambient temperature, weather (weather condition), space use current status) is input, an adequate temperature of the heat medium may be acquired according to the machine learning. That is, the control device 110 may immediately set the appropriate temperature without having to change the temperature by 1° C.

So far, cooling has been explained. A similar process may be applied to the heating. For example, when the measured temperature change rate is greater than the target temperature change rate in the heating, the control device 110 may decrease the temperature by one degree (e.g., 1° C.).

So far, the temperature has been increased. However, in some cases, the control device 110 may lower the temperature. For example, when the measured temperature change rate is lower than the target temperature change rate and the difference of the measured temperature change rate and the target temperature change rate is below a threshold, the control device 110 may decrease the temperature of the heat medium for the fast cooling. In cooling, when the measured temperature change rate is lower than the target temperature change rate and the difference of the measured temperature change rate and the target temperature change rate is below the threshold, the control device 110 may increase the temperature of the heat medium for the fast heating.

FIG. 14 is a flowchart illustrating an example machine learning method in an air conditioning system according to an example embodiment of the present disclosure. FIG. 14 illustrates an example operating method of the control device 110.

Referring to FIG. 14, in operation 1401, the control device measures the time taken to reach the target temperature. For example, the control device measures the time taken from the start of the control for adjusting the indoor temperature to the target temperature to the convergence of the indoor temperature at the target temperature. When the difference of the indoor temperature and the target temperature or the difference of the measured temperature change and the target temperature change falls below a threshold, the control device may determine that the indoor temperature is converged.

In operation 1403, the control device compares the convergence time with a time threshold. For example, the control device determines whether the time taken to reach the target temperature is greater than the threshold. When the time falls below the threshold, the control device finishes this process. On the other hand, when the time exceeds the threshold, the control device proceeds to operation 1405.

In operation 1405, the control device updates control criterion information. The control criterion information may include information for determining the temperature and the flow of the heat medium and the rotational speed of the fan. For example, the control criterion information may include Table 1 through Table 9. For example, to reduce the time taken to reach the target temperature, the control device updates the control criterion information (e.g., table) to increase the change of the control factor such as temperature. For example, the control device may shift the control factor values defined in Table 1 through Table 9 or increase all of the control factor values. For example, when the time taken for the temperature of at least one of the spaces to reach the target temperature exceeds the threshold, the control device may update the mapping information used to determine the temperature and the flow of the heat medium and the rotational speed of the fans.

As set forth above, the air conditioning system may control the temperature more efficiently.

The methods described in the claims or the detailed description of the present disclosure may be implemented in software, firmware, hardware (e.g., circuitry), or in their combinations.

The software may be stored in a computer-readable storage medium. The computer-readable storage medium stores at least one program (software module), when executed by at least one processor in an electronic device, including instructions causing the electronic device to execute the method the present disclosure.

Such software may be stored in volatile or non-volatile storage devices such as a Read Only Memory (ROM), memories such as a Random Access Memory (RAM), a memory chip, a device, or an integrated circuit, or optical or magnetic readable media such as a Compact Disc (CD)-ROM, a Digital Versatile Disc (DVD), a magnetic disk, or a magnetic tape.

A storage device and a storage medium are an example of machine-readable storage media which are suitable for storing a program including instructions to implement the embodiments, or programs. Therefore, the present disclosure provides a program including codes to implement an apparatus or a method according to any one of the claims of the present disclosure, and a machine-readable storage medium including the program. Further, such programs may be transferred electronically through a medium such as a communication signal transferred through a wired or wireless connection, and may appropriately include an equivalent medium.

In the example embodiments of the present disclosure, the elements included in the disclosure are expressed in a singular or plural form. However, the singular or plural expression is appropriately selected according to a proposed situation for the convenience of explanation and the present disclosure is not limited to a single element or a plurality of elements. The elements expressed in the plural form may be configured as a single element and the elements expressed in the singular form may be configured as a plurality of elements.

While the disclosure has been illustrated and described with reference to certain example embodiments thereof, it will be understood by those skilled in the art that various changes in form and details may be made therein without departing from the spirit and scope of the disclosure as defined by the appended claims and their equivalents.

What is claimed is:

1. A method for controlling air conditioning of a building, comprising:
controlling a temperature of a heat medium based on a reservation rate for using spaces in the building and outside weather; and
controlling a flow of the heat medium based on at least one sensing information measured in the spaces.

2. The method of claim 1, further comprising:
controlling a fan rotational speed of fans installed in the spaces based on the at least one sensing information.

3. The method of claim 1, wherein the temperature and the flow of the heat medium are determined by predefined mapping information.

4. The method of claim 3, wherein the predefined mapping information is updated based on a time taken for a temperature of at least one of the spaces to reach a target temperature.

5. The method of claim 1, wherein the temperature of the heat medium changes based on a temperature change of at least one of the spaces.

6. The method of claim 5, wherein controlling the temperature of the heat medium comprises:
increasing or decreasing the temperature of the heat medium if a difference of a measured temperature change rate and a target temperature change rate exceeds a predetermined allowable range, and
wherein the target temperature change rate is determined based on a difference between a current temperature of the heat medium and an indoor temperature of one of the spaces.

7. The method of claim 1, wherein the temperature of the heat medium is determined based on a use pattern of the spaces determined based on a reservation status of the spaces.

8. The method of claim 7, wherein the use pattern of the spaces is determined by summing a weight of at least one reserved space of the spaces.

9. The method of claim 1, wherein controlling the flow comprises:
retrieving at least one of a first rate value corresponding to an occupancy rate, a second rate value corresponding to a fan status installed in at least one space of the building, a third rate value corresponding to a difference of a current temperature and a setting temperature, a fourth rate value corresponding to a difference of a current ambient temperature and a predicted ambient temperature, and a fifth rate value corresponding to a difference of a current insolation and a predicted insolation; and
determining the flow based on the at least one of the first through fifth retrieved rate values.

10. The method of claim 1, further comprising:
storing at least one of a temperature of the heat medium when reaching the target temperature and the flow of the heat medium, as reference information for controlling the temperature and the flow if a temperature of at least one of the spaces reaches a target temperature.

11. An apparatus for controlling air conditioning of a building, comprising:
communication circuitry configured to receive information; and
processing circuitry configured to execute an operation to control the air conditioning of the building based on the information,
wherein the operation comprises controlling a temperature of a heat medium based on a reservation rate for using spaces in the building and outside weather, and a flow of the heat medium based on at least one sensing information measured in the spaces.

12. The apparatus of claim 11, wherein the operation further comprises controlling a fan rotational speed of fans installed in the spaces based on the at least one sensing information.

13. The apparatus of claim 11, wherein the operation further comprises determining temperature and the flow of the heat medium by predefined mapping information.

14. The apparatus of claim 13, wherein the operation further comprises updating the predefined mapping information based on a time taken for a temperature of at least one of the spaces to reach a target temperature.

15. The apparatus of claim 11, wherein the operation further comprises changing the temperature of the heat medium gradually based on a temperature change of at least one of the spaces.

16. The apparatus of claim 15, wherein, the operation further comprises changing the temperature of the heat medium if a difference of a measured temperature change rate and a target temperature change rate exceeds a predetermined allowable range, and
wherein the target temperature change rate is determined based on a difference between a current temperature of the heat medium and an indoor temperature of one of the spaces.

17. The apparatus of claim 11, wherein the operation further comprises determining a temperature of the heat medium based on a use pattern of the spaces determined based on a reservation status of the spaces.

18. The apparatus of claim 17, wherein the operation further comprises determining a use pattern of the spaces by summing a weight of at least one reserved space of the spaces.

19. The apparatus of claim 11, wherein, to determine the flow of the heat medium, the operation further comprises retrieving at least one of a first rate value corresponding to an occupancy rate, a second rate value corresponding to a fan status installed in at least one space of the building, a third rate value corresponding to a difference of a current temperature and a setting temperature, a fourth rate value corresponding to a difference of a current ambient temperature and a predicted ambient temperature, and a fifth rate value corresponding to a difference of a current insolation and a predicted insolation, and determines the flow based on at least one of the first to fifth received rate values.

20. The apparatus of claim 11, wherein, if a temperature of at least one of the spaces reaches a target temperature, the operation includes storing at least one of a temperature of the heat medium when reaching the target temperature and the flow of the heat medium, as reference information for controlling the temperature and the flow.
